(19) United States
(12) Patent Application Publication
(10) Pub. No.: US 2018/0308437 A1
(43) Pub. Date: Oct. 25, 2018

(54) DRIVING METHOD FOR A LIQUID CRYSTAL DISPLAY WITH TRI-GATE DRIVING ARCHITECTURE

(71) Applicant: Shenzhen China Star Optoelectronics Technology Co., Ltd., Shenzhen City (CN)

(72) Inventor: Sikun Hao, Shenzhen City (CN)

(21) Appl. No.: 15/539,691

(22) PCT Filed: May 18, 2017
(86) PCT No.: PCT/CN2017/084971

§ 371 Date: Jun. 26, 2017

(30) Foreign Application Priority Data
Apr. 17, 2017 (CN) 201710249940.8

(51) Int. Cl. G09G 3/36; G02F 1/133

(52) U.S. Cl. CPC G09G 3/3607; G09G 3/3648; G02F 1/13306

(57) ABSTRACT

The present invention provides a driving method for a liquid crystal display with Tri-gate driving architecture. The liquid crystal display with Tri-gate driving architecture comprises a plurality of sub-pixels in an array arrangement. The sub-pixels comprise red sub-pixels, green sub-pixels and blue sub-pixels. Each sub-pixel is electrically connected to a scanning line and a data line. The sub-pixels of each column are arranged from top to bottom according to a preset sub-pixel-color order. Color of the sub-pixels in each row is the same. The driving is orderly carried out with interval of 3N columns, and N is a natural number larger than 1. When driving each 3N columns interval, from top to bottom, the sub-pixels of the N rows with a first color are continuously driven first, then the sub-pixels of the N rows with a second color are continuously driven, and finally the sub-pixels of the N rows with a third color are continuously driven. The driving method for a liquid crystal display with Tri-gate driving architecture of the present invention can enhance the charging rate of the single-colored images and eliminate the color shift and display unevenness caused by insufficient pixel charging.

### BACKGROUND OF THE INVENTION

### Field of Invention

The present invention relates to the field of liquid crystal display, and more particularly to a driving method for a liquid crystal display with Tri-gate driving architecture.

### Description of Prior Art

LCDs are currently the most widely used flat panel displays, has gradually become a variety of electronic devices such as mobile phones, personal digital assistants (PDA), digital camera, computer screen or laptop screen is widely used with high-resolution color screen monitor. Currently liquid crystal displays commonly used, usually the upper and lower liquid crystal substrate and the intermediate layer, the substrate has a composition of glass and the electrode. If the upper and lower substrates both have display electrodes may be formed of the longitudinal electric field mode, such as Twist Nematic (TN) mode, Vertical Alignment (VA) mode, and Multi-domain Vertical Alignment (MVA) mode developed for solving an over-narrow viewing angle. Another type different from said display device, the electrode only on one side of the substrate, a transverse electric field mode display, such as IPS (In-plane switching, in-plane switching) mode, Fringe Field Switching (FFS) mode.

FIG. 1 shows two driving architecture diagrams commonly used in the conventional LCD display, the left side is a normal driving architecture; the right side is a Tri-gate driving architecture. The schematic diagrams of the two driving architecture contains the same number of RGB sub-pixels, the scanning lines G1, G2 . . . are on the horizontal direction, the data lines D1, D2 . . . are on the vertical direction. In the Tri-gate driving architecture, the number of data lines is reduced to ⅓ of the normal driving architecture, and the number of Gate lines increases by three times to the normal driving architecture, then, the data chip on film (Data-COF) of the Tri-gate driving architecture is reduced to ⅓ of the Normal driving architecture, and the width and charge time of each gate pulse are reduced to ⅓ of the Normal driving architecture.

FIG. 2 shows a schematic drawing of a single-colored image of the Tri-gate driving architecture, only the green (G) sub-pixels are driven, the green single-colored image is displayed.

When the single-colored image is shown in FIG. 2, the driving waveform of the Tri-gate driving architecture is shown in FIG. 3. Since the voltage of the Data line is always in variation status between high and low, the single-colored image is a re-loading image for the Tri-gate driving architecture, the charge capacity of pixels is very poor, in other words, the pixels are easy to charge insufficient, resulting in poor image display and reducing the display quality.

FIG. 4 is a schematic drawing showing a connection pattern of the pixels of the conventional liquid crystal display. According to the connection method shown in FIG. 4, a plurality of sub-pixels are arranged in an array including red sub-pixel R, green sub-pixel G, and blue sub-pixel B Each sub-pixel electrically connecting a scanning line and a data line. The red sub-pixel R, the green sub-pixel and the blue sub-pixel B in each column of the sub-pixel are alternately arranged in a repeating order. Each column of the sub-pixel is the sub-pixels with the same color. Each complete pixel includes one red sub-pixel R, one green sub-pixel G and one blue sub-pixel B, such as the sub-pixels R11, G11 and B11 form one complete pixel.

FIG. 5 is an illustrative diagram of the liquid crystal display shown in FIG. 4 with applying a conventional driving method, the driving method from top to bottom is (RGB)→(RGB)→(RGB) . . . , that is, the scanning lines G1, G2, G3 are opened orderly, being driven with this cycle. The pixels of the same raw are driven with the same way. When the single-colored image is displayed, the driving waveform is shown as FIG. 3. The data lines are driven by the IC driving voltage provided by the data driver IC. Since the voltage on the data lines are always in the variation status between high and low, the single-colored image is a re-loading image for the Tri-gate driving architecture, the charge capacity of pixels is very poor, and in other words, the pixels are easy to charge insufficient, resulting in poor image display and reducing the display quality.

### SUMMARY OF THE INVENTION

Hence, the objective of the present invention is to provide a driving method for a liquid crystal display with Tri-gate driving architecture, to enhance the charging rate of single-colored images.

In order to achieve the objective, the present invention provides a driving method for a liquid crystal display with Tri-gate driving architecture. The liquid crystal display with Tri-gate driving architecture comprises a plurality of sub-pixels in an array arrangement. The sub-pixels comprise red sub-pixels, green sub-pixels and blue sub-pixels. Each sub-pixel is electrically connected to a scanning line and a data line. The sub-pixels of each column are arranged from top to bottom according to a preset sub-pixel-color order. Color of the sub-pixels in each row is the same. The driving is orderly carried out with interval of 3N columns, and N is a natural number larger than 1. When driving each 3N columns interval, from top to bottom, the sub-pixels of the N rows with a first color are continuously driven first, then the sub-pixels of the N rows with a second color are continuously driven, and finally the sub-pixels of the N rows with a third color are continuously driven.

Wherein the preset sub-pixel-color order is the red sub-pixel, the green sub-pixel and the blue sub-pixel, from top to bottom.

Wherein the preset sub-pixel-color order is the red sub-pixel, the blue sub-pixel and the green sub-pixel, from top to bottom.

Wherein the preset sub-pixel-color order is the green sub-pixel, the red sub-pixel and the blue sub-pixel, from top to bottom.

Wherein the preset sub-pixel-color order is the green sub-pixel, the blue sub-pixel and the red sub-pixel, from top to bottom.

Wherein the preset sub-pixel-color order is the blue sub-pixel, the green sub-pixel and the red sub-pixel, from top to bottom.

Wherein the preset sub-pixel-color order is the blue sub-pixel, the red sub-pixel and the green sub-pixel, from top to bottom.

Wherein the N is equal to 2.

Wherein the N is equal to 3.

Wherein the N is equal to 4.

In order to achieve the objective, the present invention provides a driving method for a liquid crystal display with Tri-gate driving architecture. The liquid crystal display with Tri-gate driving architecture comprises a plurality of sub-pixels in an array arrangement. The sub-pixels comprise red sub-pixels, green sub-pixels and blue sub-pixels. Each sub-pixel is electrically connected to a scanning line and a data line. The sub-pixels of each column are arranged from top to bottom according to a preset sub-pixel-color order. Color of the sub-pixels in each row is the same. The driving is orderly carried out with interval of 3N columns, and N is a natural number larger than 1. When driving each 3N columns interval, from top to bottom, the sub-pixels of the N rows with a first color are continuously driven first, then the sub-pixels of the N rows with a second color are continuously driven, and finally the sub-pixels of the N rows with a third color are continuously driven.

Wherein the preset sub-pixel-color order is the red sub-pixel, the green sub-pixel and the blue sub-pixel, from top to bottom.

Wherein the N is equal to 3.

Summary, the driving method for a liquid crystal display with Tri-gate driving architecture of the present invention can enhance the charging rate of the single-colored images and eliminate the color shift and display unevenness caused by insufficient pixel charging.

### BRIEF DESCRIPTION OF THE DRAWINGS

For better understanding the technical proposals and other beneficial effects of the present invention, please refer the following detailed description of the present invention with the accompanying drawings.

FIG. 1 shows two driving architecture diagrams commonly used in the conventional LCD display.

FIG. 2 shows a schematic drawing of a single-colored image of the Tri-gate driving architecture.

FIG. 3 shows an illustrative diagram of the driving waveform when the Tri-gate driving architecture displays the single-colored images.

FIG. 4 is a schematic drawing showing a connection pattern of the pixels of the conventional liquid crystal display.

FIG. 5 is an illustrative diagram of the liquid crystal display shown in FIG. 4 with applying a conventional driving method.

FIG. 6 is an illustrative diagram of the liquid crystal display shown in FIG. 4 with applying a driving method according to the present invention.

FIG. 7 is an illustrative diagram of one preferred embodiment according to a driving method for a liquid crystal display with Tri-gate driving architecture of the present invention.

FIG. 8 shows an illustrative diagram of the driving waveform of the single-colored images according to the embodiment of FIG. 7.

FIG. 9 shows an illustrative diagram of the driving waveform of the single-colored images while applying the conventional driving method.

FIG. 10 is a driving time-domain diagram of the single-colored image according to the embodiment of FIG. 7.

FIG. 11 is a driving time-domain diagram of the single-colored image while applying the conventional driving method.

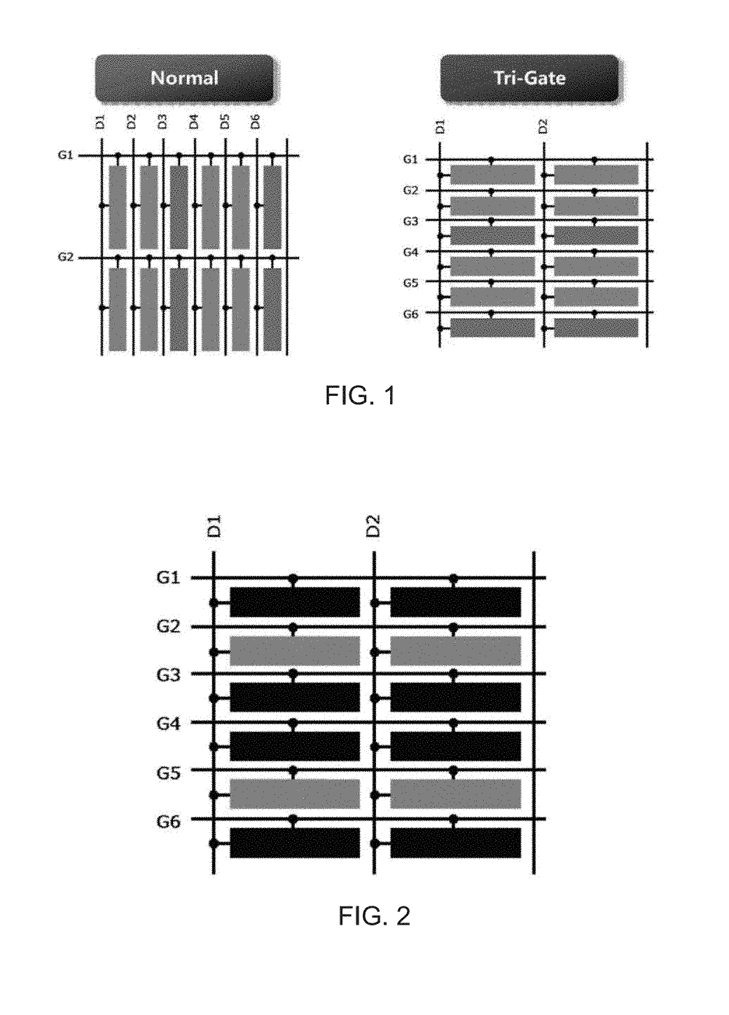

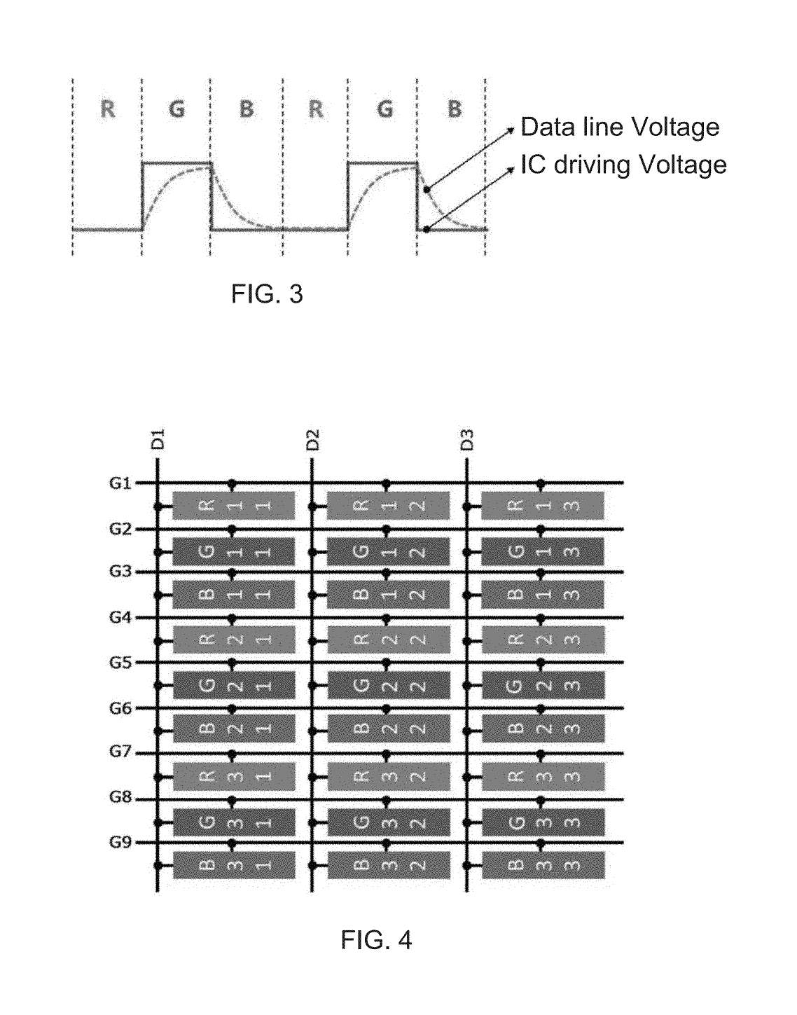

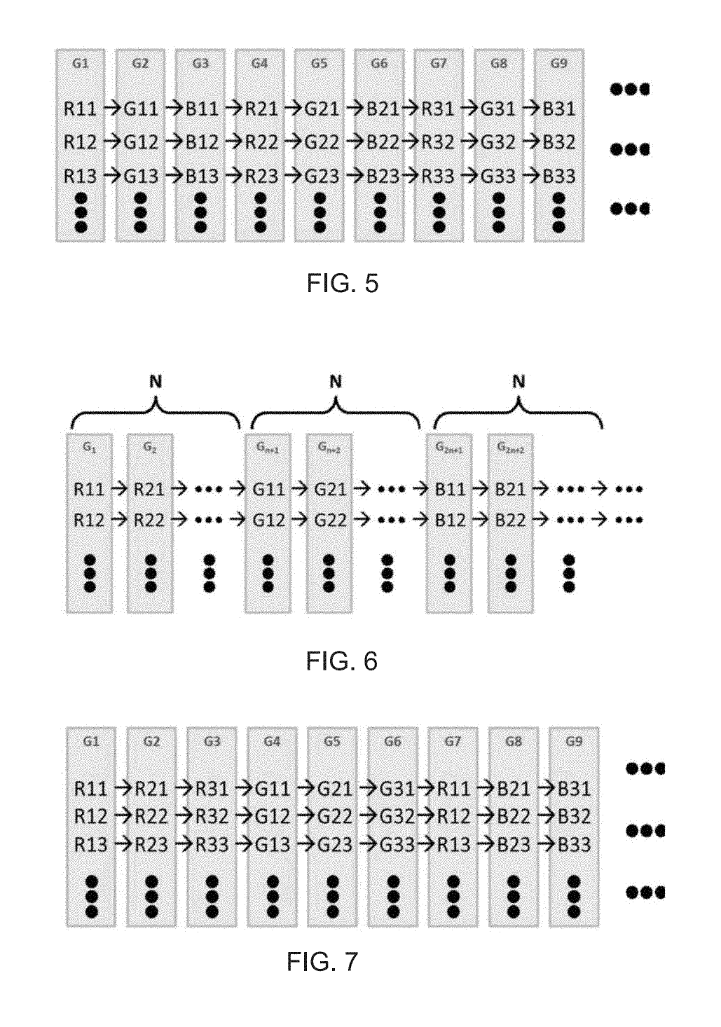

### DETAILED DESCRIPTION OF THE PREFERRED EMBODIMENTS

The same as the conventional art, the connection method of the pixels of the liquid crystal display of the present invention is also shown in FIG. 4, and the inventive point of the present invention is a driving method for the liquid crystal display.

FIG. 6 is an illustrative diagram of the liquid crystal display shown in FIG. 4 with applying a driving method according to the present invention. From top to bottom, the driving method is (RR . . . )→(GG . . . )→(BB . . . )→ . . . . The N scanning lines corresponding to the red sub-pixels R are opened, the N scanning lines corresponding to the green sub-pixel G are opened and the N scanning lines of corresponding to the blue sub-pixel B are opened. The driving method for the pixels of the same column is the same with this cycle. The present invention provides a driving method for a liquid crystal display with Tri-gate driving architecture in which N red sub-pixels R, N green sub-pixels G and N blue sub-pixels B are successively driven, when the single-colored image is displayed, to enhance the charging rate of the single-colored images and to eliminate the color shift and display unevenness caused by insufficient pixel charging.

The liquid crystal display of the driving method for a liquid crystal display with Tri-gate driving architecture comprises a plurality of sub-pixels in an array arrangement. The sub-pixels comprise red sub-pixels R, green sub-pixels G and blue sub-pixels B. Each sub-pixel is electrically connected to a scanning line and a data line. The sub-pixels of each column are arranged from top to bottom according to a preset sub-pixel-color order. The order is random, such as R, B, R, B . . . or R, B, R, B, G . . . , color of the sub-pixels in each row are the same. The driving is orderly carried out with interval of 3N columns, and N is a natural number larger than 1. When driving each 3N columns interval, from top to bottom, the sub-pixels of the N rows with a first color are continuously driven first, then the sub-pixels of the N rows with a second color are continuously driven, and finally the sub-pixels of the N rows with a third color are continuously driven, to open the scanning lines at the corresponding columns. According to the quest, the N can be selected as 2, 3, 4, 5 . . . etc.

FIG. 7 is an illustrative diagram of one preferred embodiment according to a driving method for a liquid crystal display with Tri-gate driving architecture of the present invention. From top to bottom, the driving method is (RRR)→(GGG)→(BBB)→ . . . . That is, the N is equal to three, the driving method is performed according to an interval of 3×3 columns, the three scanning lines corresponding to the red sub-pixels R are opened, the three scanning lines corresponding to the green sub-pixel G are opened and the three scanning lines of corresponding to the blue sub-pixel B are opened, the corresponding scanning lines are opened. The driving method for the pixels of the same column of the array arrangement is the same with this cycle. The present invention provides a driving method for a liquid crystal display with Tri-gate driving architecture in which three red sub-pixels R, three green sub-pixels G and three blue sub-pixels B are successively driven, when the single-colored image is displayed.

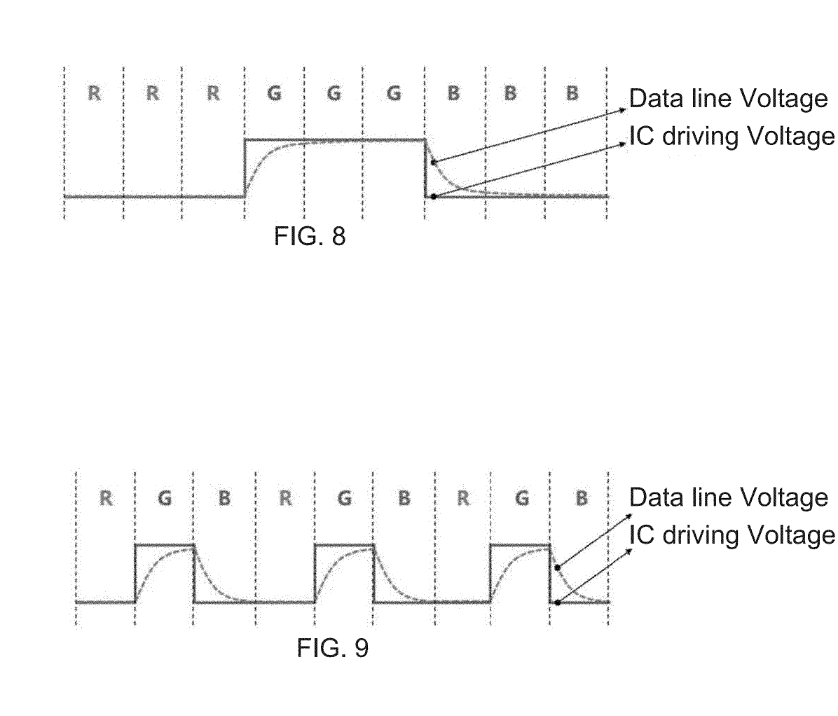

FIG. 8 shows an illustrative diagram of the driving waveform of the single-colored images according to the embodiment of FIG. 7. FIG. 9 shows an illustrative diagram of the driving waveform of the single-colored images while applying the conventional driving method. Compared the FIG. 8 and the FIG. 9, when applying the driving method of the present invention to a single-colored image, three pixels G can be continuously driven, and the charging rate of the latter two pixels G pixels is greatly improved, and the charging rate of the latter two pixels B pixels is greatly improved. It can reduce the IC load, enhance the charging rate of the single-colored images and eliminate the color shift and display unevenness caused by insufficient pixel charging.

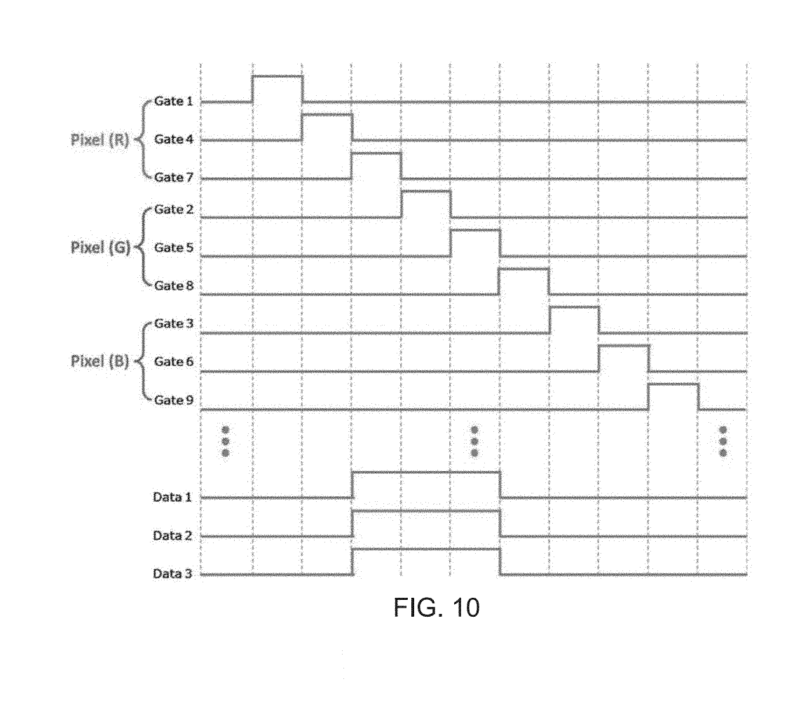

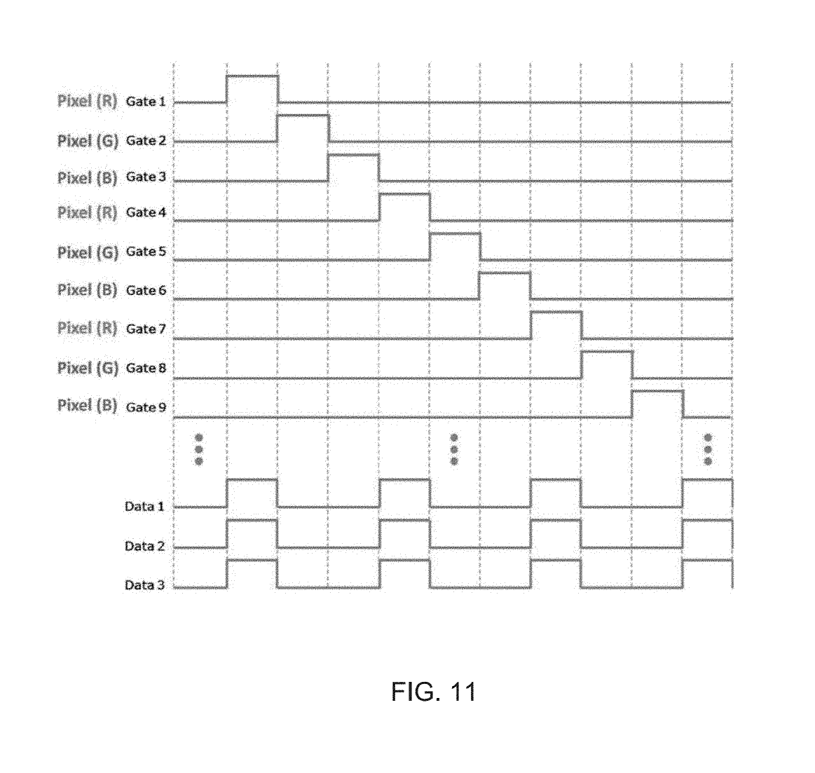

FIG. 10 is a driving time-domain diagram of the single-colored image according to the embodiment of FIG. 7. As a comparison, FIG. 11 is a driving time-domain diagram of the single-colored image while applying the conventional driving method. In the conventional driving method, the scanning lines G1, G2, G3, . . . are sequentially opened in the order according to the original scanning lines, and in the driving method of the present invention, in order to continuously drive the single-colored pixels, the connection pattern corresponding to the liquid crystal display pixels, the scanning lines are opened in the order of G1, G4, G7, G2, G5, G8, G3, G6, G9, so that the data lines can continuously charge the three single-colored pixels of the same color to enhance the charging rate of the single-colored image.

In summary, the driving method for a liquid crystal display with Tri-gate driving architecture of the present invention can enhance the charging rate of the single-colored images and to eliminate the color shift and display unevenness caused by insufficient pixel charging.

As mentioned above, those of ordinary skill in the art, without departing from the spirit and scope of the present disclosure, can make various kinds of modifications and variations to the present disclosure. Therefore, all such modifications and variations are intended to be included in the protection scope of the appended claims of the present invention.

What is claimed is:

1. A driving method for a liquid crystal display with Tri-gate driving architecture, the liquid crystal display with Tri-gate driving architecture comprising a plurality of sub-pixels in an array arrangement, the sub-pixels comprising red sub-pixels, green sub-pixels and blue sub-pixels, each sub-pixel being electrically connected to a scanning line and a data line, the sub-pixels of each column are arranged from top to bottom according to a preset sub-pixel-color order, color of the sub-pixels in each row being the same; the driving is orderly carried out with interval of 3N columns, and N being a natural number larger than 1, when driving each 3N columns interval, from top to bottom, the sub-pixels of the N rows with a first color being continuously driven first, then the sub-pixels of the N rows with a second color being continuously driven, and finally the sub-pixels of the N rows with a third color being continuously driven.

2. The driving method for a liquid crystal display with Tri-gate driving architecture according to claim 1, wherein the preset sub-pixel-color order is the red sub-pixel, the green sub-pixel and the blue sub-pixel, from top to bottom.

3. The driving method for a liquid crystal display with Tri-gate driving architecture according to claim 1, wherein the preset sub-pixel-color order is the red sub-pixel, the blue sub-pixel and the green sub-pixel, from top to bottom.

4. The driving method for a liquid crystal display with Tri-gate driving architecture according to claim 1, wherein the preset sub-pixel-color order is the green sub-pixel, the red sub-pixel and the blue sub-pixel, from top to bottom.

5. The driving method for a liquid crystal display with Tri-gate driving architecture according to claim 1, wherein the preset sub-pixel-color order is the green sub-pixel, the blue sub-pixel and the red sub-pixel, from top to bottom.

6. The driving method for a liquid crystal display with Tri-gate driving architecture according to claim 1, wherein the preset sub-pixel-color order is the blue sub-pixel, the green sub-pixel and the red sub-pixel, from top to bottom.

7. The driving method for a liquid crystal display with Tri-gate driving architecture according to claim 1, wherein the preset sub-pixel-color order is the blue sub-pixel, the red sub-pixel and the green sub-pixel, from top to bottom.

8. The driving method for a liquid crystal display with Tri-gate driving architecture according to claim 1, wherein the N is equal to 2.

9. The driving method for a liquid crystal display with Tri-gate driving architecture according to claim 1, wherein the N is equal to 3.

10. The driving method for a liquid crystal display with Tri-gate driving architecture according to claim 1, wherein the N is equal to 4.

11. A driving method for a liquid crystal display with Tri-gate driving architecture, the liquid crystal display with Tri-gate driving architecture comprising a plurality of sub-pixels in an array arrangement, the sub-pixels comprising red sub-pixels, green sub-pixels and blue sub-pixels, each sub-pixel being electrically connected to a scanning line and a data line, the sub-pixels of each column are arranged from top to bottom according to a preset sub-pixel-color order, color of the sub-pixels in each row being the same; the driving is orderly carried out with interval of 3N columns, and a N being a natural number larger than 1, when driving each 3N columns interval, from top to bottom, the sub-pixels of the N rows with a first color being continuously driven first, then the sub-pixels of the N rows with a second color being continuously driven, and finally the sub-pixels of the N rows with a third color being continuously driven;
wherein the preset sub-pixel-color order is the red sub-pixel, the green sub-pixel and the blue sub-pixel, from top to bottom;
wherein the N is equal to 3.
